(19) United States
(12) Patent Application Publication
(10) Pub. No.: US 2025/0042418 A1
(43) Pub. Date: Feb. 6, 2025

(54) ADAPTING PERFORMANCE LEVEL OF RUNNABLES BASED ON SAFETY RATINGS

(71) Applicant: Mercedes-Benz Group AG, Stuttgart (DE)

(72) Inventor: Francois PIEDNOEL, Sunnyvale, CA (US)

(21) Appl. No.: 18/229,491

(22) Filed: Aug. 2, 2023

(51) Int. Cl. B60W 50/02; B60W 60/00

(52) U.S. Cl. CPC B60W 50/0205; B60W 60/0015

(57) ABSTRACT

A computing system can include a sensor data input chiplet to obtain sensor data from a sensor system, a set of workload processing chiplets, and a central chiplet comprising a shared memory including a scheduling program for scheduling a set of runnables to execute based at least partially on the sensor data, where the set of runnables are included in a software structure. the set of runnables can be executed by the set of workload processing chiplets. Each runnable and each connection between runnables in the set of runnables can be associated with a safety rating to facilitate degradation of execution of the software structure.

### BACKGROUND

Universal Chiplet Interconnect Express (UCIe) provides an open specification for an interconnect and serial bus between chiplets, which enables the production of large system-on-chip (SoC) packages with intermixed components from different silicon manufacturers. It is contemplated that autonomous vehicle computing systems may operate using chiplet arrangements that follow the UCIe specification. One goal of creating such computing systems is to achieve the robust safety integrity levels of other important electrical and electronic (E/E) automotive components of the vehicle.

### SUMMARY

Systems and methods are described herein for scheduling a set of runnables included in a software structure for execution by a set of workload processing chiplets. In accordance with the scheduling program, each runnable and/or each connection between runnables in the software structure can be associated with a safety rating (e.g., an automotive safety integrity level (ASIL) rating) to facilitate degradation of the software structure. In various examples, the set of workload processing chiplets can be included on a system-on-chip (SoC) that includes a central chiplet comprising the scheduling program and a reservation table that includes workload information (e.g., dependency information for when workloads are available for execution as runnables by the workload processing chiplets).

In certain implementations, the central chiplet can include a functional safety (FuSa) program that (i) monitors communications corresponding to execution of the runnables by the set of workload processing chiplets, and (ii) triggers the degradation of the software structure upon detecting data corresponding to a system overload, processing delay, overheating, or other issues affecting the SoC that require system degradation. In response to the FuSa program triggering the degradation, the scheduling program performs the degradation of the software structure based on the safety rating of each runnable and/or each connection between the runnables in the software structure. In some examples, the degradation of the software structure by the scheduling program can comprise reducing an execution frequency of a select set of runnables in the software structure. In further examples, the scheduling program can reduce the execution frequency of the select set of runnables using a reservation table that identifies when the select set of runnables are ready for execution (e.g., based on dependency information being satisfied). Additionally or alternatively, the degradation can comprise morphing and/or truncating the software structure to change connections between runnables or exclude certain runnables from executing (e.g., runnables having low safety ratings). In further examples, the degradation can comprise switching between compute graphs or software structures hierarchically (e.g., utilizing level one degradation compute graph, level two degradation compute graph, level three degradation compute graph, etc.).

According to various embodiments, the adaptable performance of runnables in the SoC can be implemented for autonomous vehicle operation. For example, the SoC can include a sensor data input chiplet, the set of workload processing chiplets, and the central chiplet, and can be included on a UCIe SoC arrangement. This SoC arrangement can further include one or more machine learning (ML) accelerator chiplets, high-bandwidth memory (HBM) chiplets, and/or autonomous drive chiplets.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram depicting an example computing system in which embodiments described herein may be implemented, in accordance with examples described herein;

FIG. 2 is a block diagram depicting a system-on-chip (SoC) in which examples described herein may be implemented, in accordance with examples described herein;

FIG. 3 is a block diagram illustrating an example central chiplet of an SoC arrangement for executing runnables, in accordance with examples described herein;

FIG. 4 depicts a software structure comprised of a set of runnables to be executed by workload processing chiplets, according to examples described herein;

FIG. 5 is a block diagram depicting an example multiple system-on-chip (mSoC), in accordance with examples described herein;

FIG. 6 is a block diagram depicting a performance network and a FuSa network for performing health monitoring, error correction, and system degradation, according to examples described herein; and

FIGS. 7 and 8 are flow charts describing example methods of adapting runnables based on safety rating, according to various examples.

### DETAILED DESCRIPTION

In experimentation and controlled testing environments, system redundancies and automotive safety integrity level (ASIL) ratings for autonomy systems are not typically a priority consideration. As autonomous driving features continue to advance (e.g., beyond Level 3 autonomy), and autonomous vehicles begin operating more commonly on public road networks, the qualification and certification of E/E components related to autonomous operation of the vehicle will be advantageous to ensure operational safety of these vehicles. Furthermore, novel methods for qualifying and certifying hardware, software, and/or hardware/software combinations will also be advantageous in increasing public confidence and assurance that autonomous driving systems are safe beyond current standards. For example, certain safety standards for autonomous driving systems include safety thresholds that correspond to average human abilities and care. Yet, these statistics include vehicle incidences involving impaired or distracted drivers and do not factor in specified time windows in which vehicle operations are inherently riskier (e.g., inclement weather conditions, late night driving, winding mountain roads, etc.).

Automotive safety integrity level (ASIL) is a risk classification scheme defined by ISO 26262 (the functional safety for road vehicles standard), and is typically established for the E/E components of the vehicle by performing a risk analysis of potential hazards, which involves determining respective levels of severity (i.e., the severity of injuries the hazard can be expected to cause; classified between S0 (no injuries) and S3 (life-threatening injuries)), exposure (i.e., the relative expected frequency of the operational conditions in which the injury can occur; classified between E0 (incredibly unlikely) and E4 (high probability of injury under most operating conditions)), and controllability (i.e., the relative likelihood that the driver can act to prevent the injury; classified between C0 (controllable in general) and C3 difficult to control or uncontrollable)) of the vehicle operating scenario. As such, the safety goal(s) for any potential hazard event includes a set of ASIL requirements.

Hazards that are identified as quality management (QM) do not dictate any safety requirements. As an illustration, these QM hazards may be any combination of low probability of exposure to the hazard, low level of severity of potential injuries resulting from the hazard, and a high level of controllability by the driver in avoiding the hazard and/or preventing injuries. Other hazard events are classified as ASIL-A, ASIL-B, ASIL-C, or ASIL-D depending on the various levels of severity, exposure, and controllability corresponding to the potential hazard. ASIL-D events correspond to the highest integrity requirements (ASIL requirements) on the safety system or E/E components of the safety system, and ASIL-A comprises the lowest integrity requirements. As an example, the airbags, anti-lock brakes, and power steering system of a vehicle will typically have an ASIL-D grade, where the risks associated with the failure of these components (e.g., the probable severity of injury and lack of vehicle controllability to prevent those injuries) are relatively high.

As provided herein, the ASIL may refer to both risk and risk-dependent requirements, where the various combinations of severity, exposure, and controllability are quantified to form an expression of risk (e.g., an airbag system of a vehicle may have a relatively low exposure classification, but high values for severity and controllability). As provided above, the quantities for severity, exposure, and controllability for a given hazard are traditionally determined using values for severity (e.g., S0 through S3), exposure (e.g., E0 through E4), and controllability (e.g., C0 through C3) in the ISO 26262 series, where these values are then utilized to classify the ASIL requirements for the components of a particular safety system. As provided herein, certain safety systems can perform variable mitigation measures, which can range from alerts (e.g., visual, auditory, or haptic alerts), minor interventions (e.g., brake assist or steer assist), major interventions and/or avoidance maneuvering (e.g., taking over control of one or more control mechanisms, such as the steering, acceleration, or braking systems), and full autonomous control of the vehicle.

In accordance with examples described herein, a software structure for executing autonomous vehicle or semi-autonomous vehicle functions (e.g., perception, object detection and classification, scene understanding ML inference, etc.) can comprise a set of runnables that may be connected to other runnables based on associations or input/output dependencies. As an illustration, a first runnable may be tasked with identifying and classifying pedestrians in image data, and a second runnable may be tasked with predicting the motion of each pedestrian. In this example, the second runnable would receive, as input, the output of the first runnable. As such, in the software structure, the first and second runnables are connected.

In various examples described herein, the runnables and/or the connections between runnables in the software structure can be associated with a safety rating, such as QM rating, or an ASIL-A, ASIL-B, ASIL-C, or ASIL-D rating. These safety ratings can be defined in the software structure, which can indicate the criticality of the runnable or connection between two runnables. As an example, an ASIL-D rated runnable or connection between two runnables can correspond to the identification of traffic signals and the classification of the signal states of the traffic signals (e.g., red, yellow, or green light), which can be crucial for preventing automotive collisions. As another example, an ASIL-B rated connection between two runnables can correspond to the detection, classification, and speed differential calculation of rearward vehicles in the same lane as the autonomous vehicle (e.g., since those vehicles do not have right-of-way over the autonomous vehicle).

It is contemplated that defining or associated the runnables or the connections between runnables in the software structure can facilitate in system degradation (e.g., when the computing system is experiencing critical temperatures due to overloaded computing and/or high ambient temperature). Furthermore, the degradation of the execution of the software structure can be managed by a functional safety (FuSa) component of the computing system, which can be tasked with (i) monitoring communications between runnables (e.g., the chiplets organizing the data and executing the runnables based on the data), (ii) communicating with a thermal management component of the computing system, and (iii) communicating with a workload scheduling program that manages a reservation table comprising workload entries that indicate whether workloads are available for execution in one or more runnables.

As provided herein, “degradation” of the software structure or degradation of the execution of the software structure generally refers to selectively decreasing certain compute tasks based on the safety ratings associated with runnables and/or connections between runnables. As an example, ISO 26262 refers to a degradation concept in the context of automotive safety, in which the functionality of a given system (e.g., an E/E system) is degraded to reach the safe state. As such, the autonomous system of the vehicle should be able to handle the degraded functionality in a proper way. Otherwise, the autonomous drive system can safely pull over or park the vehicle as a final backup option.

In various implementations, degradation of the software structure or degradation of the execution of the software structure can involve a scheduling program that reduces an execution frequency of a select set of runnables in the software structure. In further examples, the scheduling program can reduce the execution frequency of the select set of runnables using a reservation table that identifies when the select set of runnables are ready for execution (e.g., based on dependency information being satisfied). In still further examples, degradation can comprise reducing the processing frequency of selected device (a particular chiplet) where the runnables are run whose runnables or runnable connections have a lower safety rating (e.g., disregarding every other image or sensor data iteration), decrease or increase the frequency of how often the runnables are executed, ignoring data from certain non-critical sensors, temporarily preventing execution of certain runnables, and the like.

As provided herein, the degradation can involve changing or editing the connections between runnables and/or truncating select portions of the compute graph corresponding to the software structure to exclude one or more runnables from being executed. In additional examples, the degradation can involve changing between software structures or compute graphs entirely. For example, the vehicle can store multiple compute graphs that correspond to differing SAE autonomy levels and/or differing levels of degradation.

As further described herein, the degradation can be implemented by the scheduling program using the reservation table, which can indicate when certain workloads are available for execution as runnables. For example, the scheduling program can cause certain workloads in an out-of-order buffer of the reservation table to be flushed without being executed (e.g., data corresponding to the workload can be transferred to an HBM chiplet without being processed by a workload processing chiplet) or the reservation table can selectively delete certain workloads associated with runnables having low safety rating connections.

As provided herein, a “degradation event” can comprise any event that can trigger the degradation of the software structure or execution of the software structure, and can include excess heat in the computing system or portions of the computing system, computer hardware faults or failures, sensor faults or failures, a specified driving scenario (e.g., extreme cases of vulnerable road user traffic), vehicle faults or failures, and the like. For example, a thermal management component and functional safety component of the computing system can trigger the degradation of the software structure when other thermal mitigation measures, such as initiating fans and/or water-cooling systems and switching SoCs between primary and backup roles, are insufficient in successfully cooling the computing system.

In certain implementations, the example computing systems can perform one or more functions described herein using a learning-based approach, such as by executing an artificial neural network (e.g., a recurrent neural network, convolutional neural network, etc.) or one or more machine-learning models. Such learning-based approaches can further correspond to the computing system storing or including one or more machine-learned models. In an embodiment, the machine-learned models may include an unsupervised learning model. In an embodiment, the machine-learned models may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

As provided herein, a “network” or “one or more networks” can comprise any type of network or combination of networks that allows for communication between devices. In an embodiment, the network may include one or more of a local area network, wide area network, the Internet, secure network, cellular network, mesh network, peer-to-peer communication link or some combination thereof and may include any number of wired or wireless links. Communication over the network(s) may be accomplished, for instance, via a network interface using any type of protocol, protection scheme, encoding, format, packaging, etc.

One or more examples described herein provide that methods, techniques, and actions performed by a computing device are performed programmatically, or as a computer implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers and/or personal computers using network equipment (e.g., routers). Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a non-transitory computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of non-transitory computer-readable mediums include permanent memory storage devices, such as hard drives on personal computers or servers. Other examples of computer storage mediums include portable storage units, such as flash memory or magnetic memory. Computers, terminals, network-enabled devices are all examples of machines and devices that utilize processors, memory, and instructions stored on computer-readable mediums. Additionally, examples may be implemented in the form of computer programs, or a computer usable carrier medium capable of carrying such a program.

### Example Computing System

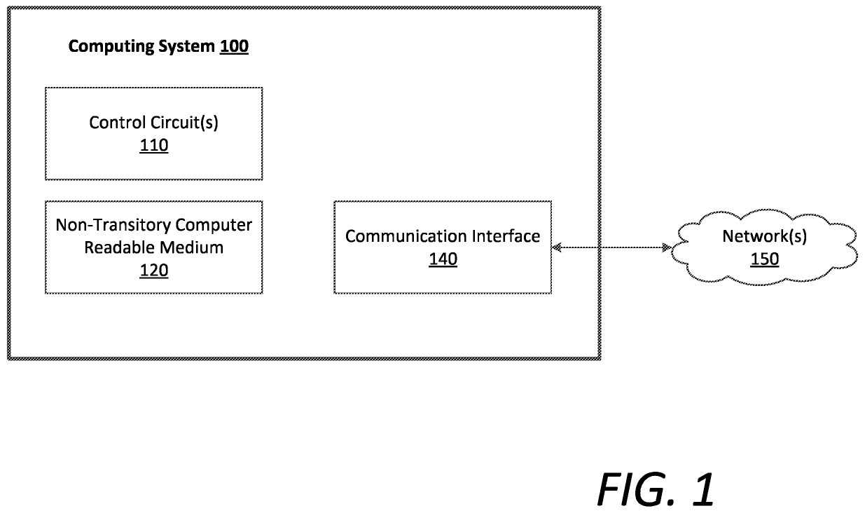

FIG. 1 is a block diagram depicting an example computing system 100 in which embodiments described herein may be implemented, in accordance with examples described herein. In an embodiment, the computing system 100 can include one or more control circuits 110 that may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), systems on chip (SoCs), or any other control circuit. In some implementations, the control circuit(s) 110 and/or computing system 100 may be part of, or may form, a vehicle control unit (also referred to as a vehicle controller) that is embedded or otherwise disposed in a vehicle (e.g., a Mercedes-Benz® car, truck, or van). For example, the vehicle controller may be or may include an infotainment system controller (e.g., an infotainment head-unit), a telematics control unit (TCU), an electronic control unit (ECU), a central powertrain controller (CPC), a central exterior & interior controller (CEIC), a zone controller, an autonomous vehicle control system, or any other controller (the term “or” is used herein interchangeably with “and/or”).

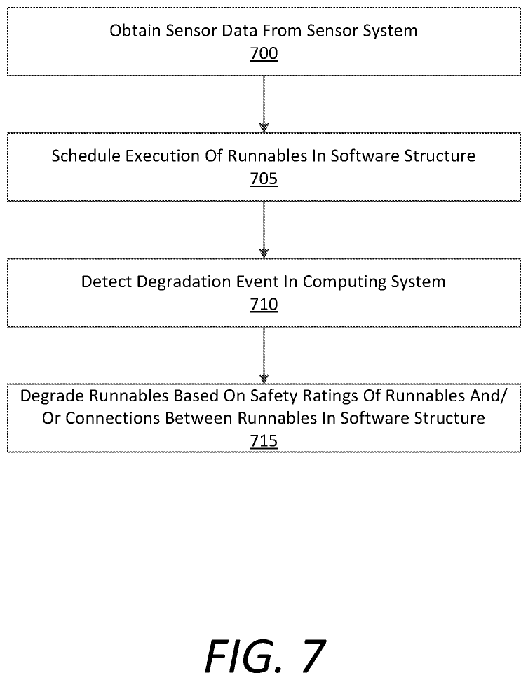

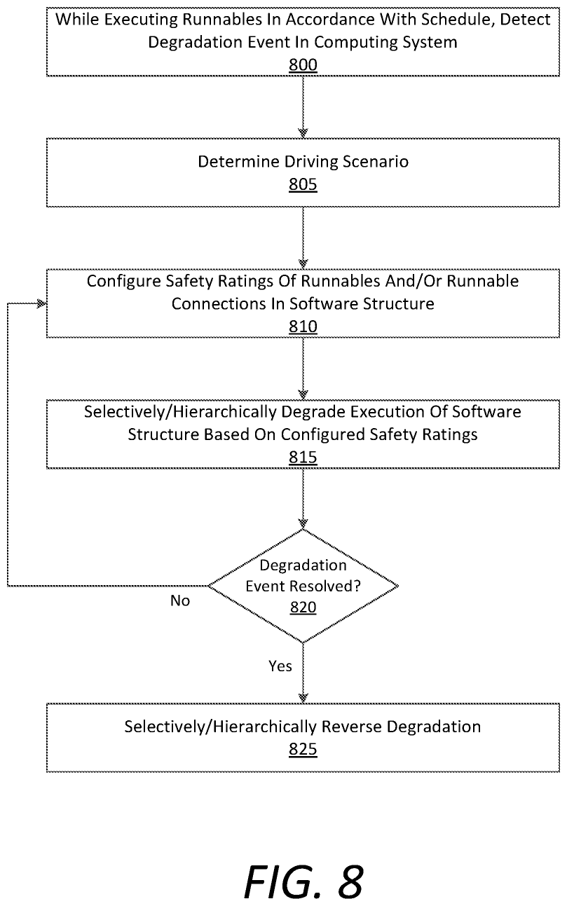

In an embodiment, the control circuit(s) 110 may be programmed by one or more computer-readable or computer-executable instructions stored on the non-transitory computer-readable medium 120. The non-transitory computer-readable medium 120 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 120 may form, for example, a computer diskette, a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick. In some cases, the non-transitory computer-readable medium 120 may store computer-executable instructions or computer-readable instructions, such as instructions to perform the below methods described in connection with FIGS. 7 and 8.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 110 to perform one or more functional tasks. The modules and computer-readable/executable instructions may be described as performing various operations or tasks when the control circuit(s) 110 or other hardware components execute the modules or computer-readable instructions.

In further embodiments, the computing system 100 can include a communication interface 140 that enables communications over one or more networks 150 to transmit and receive data. In various examples, the computing system 100 can communicate, over the one or more networks 150, with fleet vehicles using the communication interface 140 to receive sensor data and implement the methods described throughout the present disclosure. In certain embodiments, the communication interface 140 may be used to communicate with one or more other systems. The communication interface 140 may include any circuits, components, software, etc. for communicating via one or more networks 150 (e.g., a local area network, wide area network, the Internet, secure network, cellular network, mesh network, and/or peer-to-peer communication link). In some implementations, the communication interface 140 may include for example, one or more of a communications controller, receiver, transceiver, transmitter, port, conductors, software and/or hardware for communicating data/information.

As an example embodiment, the control circuit(s) 110 of the computing system 100 can include a SoC arrangement that facilitates the various methods and techniques described throughout the present disclosure. In various examples, the SoC can include a set of chiplets, including a central chiplet comprising a shared memory in which a reservation table is utilized to execute various autonomous driving workloads as runnables in independent pipelines. According to embodiments described herein, the shared memory of the central chiplet can include a FuSa program executable by the control circuit 110 to perform functional safety tasks for the SoC arrangement, as described in detail below.

### Example System-on-Chip

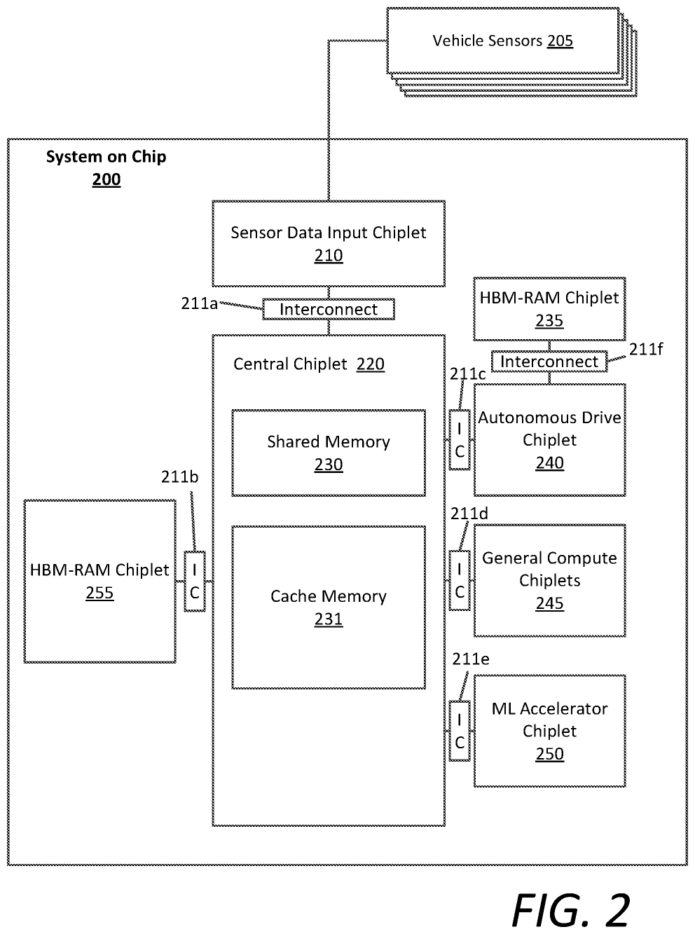

FIG. 2 is a block diagram illustrating an example system-on-chip (SoC) 200, in accordance with examples described herein. The example SoC 200 shown in FIG. 2 can include additional components, and the components of the SoC 200 may be arranged in various alternative configurations other than the example shown. Thus, the SoC 200 of FIG. 2 is described herein as an example arrangement for illustrative purposes and is not intended to limit the scope of the present disclosure in any manner.

Referring to FIG. 2, a sensor data input chiplet 210 of the SoC 200 can receive sensor data from various vehicle sensors 205 of the vehicle. These vehicle sensors 205 can include any combination of image sensors (e.g., single cameras, binocular cameras, fisheye lens cameras, etc.), LIDAR sensors, radar sensors, ultrasonic sensors, proximity sensors, and the like. The sensor data input chiplet 210 can automatically dump the received sensor data as it is received into a cache memory 231 of the central chiplet 220. The sensor data input chiplet 210 can also include an image signal processor (ISP) responsible for capturing, processing, and enhancing images taken from the various vehicle sensors 205. The ISP takes the raw image data and performs a series of complex image processing operations, such as color, contrast, and brightness correction, noise reduction, and image enhancement, to create a higher-quality image that is ready for further processing or analysis by the other chiplets of the SoC 200. The ISP may also include features such as auto-focus, image stabilization, and advanced scene recognition to further enhance the quality of the captured images. The ISP can then store the higher-quality images in the cache memory 231.

In some aspects, the sensor data input chiplet 210 publishes identifying information for each item of sensor data (e.g., images, point cloud maps, etc.) to a shared memory 230 of a central chiplet 220, which acts as a central mailbox for synchronizing workloads for the various chiplets. The identifying information can include details such as an address in the cache memory 231 where the data is stored, the type of sensor data, which sensor captured the data, and a timestamp of when the data was captured.

To communicate with the central chiplet 220, the sensor data input chiplet 210 transmits data through an interconnect 211a. Interconnects 211a-f each represent die-to-die (D2D) interfaces between the chiplets of the SoC 200. In some aspects, the interconnects 211a-f can include high-bandwidth data paths used for general data purposes to the cache memory 231 and high-reliability data paths to transmit functional safety (FuSa) and scheduler information to the shared memory 230. Depending on bandwidth requirements, an interconnect 211a-f may include more than one die-to-die interface. For example, interconnect 211a can include two interfaces to support higher bandwidth communications between the sensor data input chiplet 210 and the central chiplet 220.

In one aspect, the interconnects 211a-f implement the Universal Chiplet Interconnect Express (UCIe) standard and communicate through an indirect mode to allow each of the chiplet host processors to access remote memory as if it were local memory. This is achieved by using a specialized Network-on-Chip (NoC) Network Interface Unit (NIU) (e.g., which allows freedom of interferences between devices connected to the network) that provides hardware-level support for remote direct memory access (RDMA) operations. In UCIe indirect mode, the host processor sends requests to the NIU, which then accesses the remote memory and returns the data to the host processor. This approach allows for efficient and low-latency access to remote memory, which can be particularly useful in distributed computing and data-intensive applications. Additionally, UCIe indirect mode provides a high degree of flexibility, as it can be used with a wide range of different network topologies and protocols.

In various examples, the SoC 200 can include additional chiplets that can store, alter, or otherwise process the sensor data cached by the sensor data input chiplet 210. The SoC 200 can include an autonomous drive chiplet 240 that can perform the perception, sensor fusion, trajectory prediction, and/or other autonomous driving algorithms of the autonomous vehicle. The autonomous drive chiplet 240 can be connected to a dedicated HBM-RAM chiplet 235 in which the autonomous drive chiplet 240 can publish all status information, variables, statistical information, and/or processed sensor data as processed by the autonomous drive chiplet 240.

In various examples, the system on chip 200 can further include a machine-learning (ML) accelerator chiplet 240 that is specialized for accelerating machine-learned or AI workloads, such as image inferences or other sensor inferences using machine learning, in order to achieve high performance and low power consumption for these workloads. The ML accelerator chiplet 240 can include an engine designed to efficiently process graph-based data structures, which are commonly used in AI workloads, and a highly parallel processor, allowing for efficient processing of large volumes of data. The ML accelerator chiplet 240 can also include specialized hardware accelerators for common AI operations such as matrix multiplication and convolution as well as a memory hierarchy designed to optimize memory access for AI workloads, which often have complex memory access patterns.

The general compute chiplets 245 can provide general purpose computing for the system on chip 200. For example, the general compute chiplets 245 can comprise high-powered central processing units and/or graphical processing units that can support the computing tasks of the central chiplet 220, autonomous drive chiplet 240, and/or the ML accelerator chiplet 250.

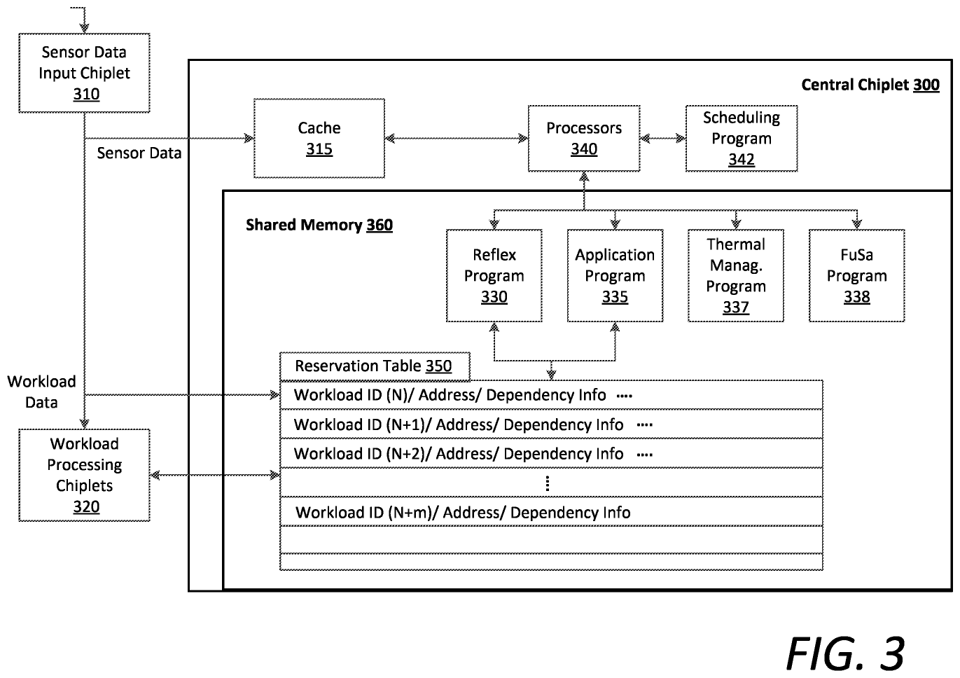

In various implementations, the shared memory 230 can store programs and instructions for performing autonomous driving tasks. The shared memory 230 of the central chiplet 220 can further include a reservation table that provides the various chiplets with the information needed (e.g., sensor data items and their locations in memory) for performing their individual tasks. In various aspects, the central chiplet 220 also includes the large cache memory 231, which supports invalidate and flush operations for stored data. Further description of the shared memory 230 in the context of the central chiplet 220 is provided below with respect to FIG. 3.

Cache miss and evictions from the cache memory 231 are sent by a high-bandwidth memory (HBM) RAM chiplet 255 connected to the central chiplet 220. The HBM-RAM chiplet 255 can include status information, variables, statistical information, and/or sensor data for all other chiplets. In certain examples, the information stored in the HBM-RAM chiplet 255 can be stored for a predetermined period of time (e.g., ten seconds) before deleting or otherwise flushing the data. For example, when a fault occurs on the autonomous vehicle, the information stored in the HBM-RAM chiplet 255 can include all information necessary to diagnose and resolve the fault. Cache memory 231 keeps fresh data available with low latency and less power required compared to accessing data from the HBM-RAM chiplet 255.

As provided herein, the shared memory 230 can house a mailbox architecture in which a reflex program comprising a suite of instructions is used to execute workloads by the central chiplet 220, general compute chiplets 245, and/or autonomous drive chiplet 240. In certain examples, the central chiplet 220 can further execute a FuSa program that operates to compare and verify outputs of respective pipelines to ensure consistency in the ML inference operations. In still further examples, the central chiplet 220 can execute a thermal management program to ensure that the various components of the SoC 200 operates within normal temperature ranges. Further description of the shared memory 230 in the context of workload execution and system degradation is provided below with respect to FIG. 3.

### Example Central Chiplet

FIG. 3 is a block diagram illustrating an example central chiplet 300 of an SoC arrangement, in accordance with examples described herein. The central chiplet 300 shown in FIG. 3 can correspond to the central chiplet 220 of the SoC 200 as shown in FIG. 2. Furthermore, the sensor data input chiplet 310 of FIG. 3 can correspond to the sensor data input chiplet 210 shown in FIG. 2, and the workload processing chiplets 320 shown in FIG. 3, can correspond to any one or more of the general compute chiplets 245, ML accelerator chiplet 250, and/or the autonomous drive chiplet 240 shown in FIG. 2. In still further examples, the processors 340 of the central chiplet 300 can also execute workloads as runnables in support of the workload processing chiplets 320.

Referring to FIG. 3, the central chiplet 300 can include a shared memory 360 that includes a reflex program 330, an application program 335, a thermal management program 337, and a functional safety (FuSa) program 338. As provided herein, the reflex program 330 can comprise a set of instructions for executing reflex workloads in independent workload pipelines. The reflex workloads can comprise sensor data acquisition, sensor fusion, and inference tasks that facilitate scene understanding of the surrounding environment of the vehicle. These tasks can comprise two-dimensional image processing, sensor fused data processing (e.g., three-dimensional LIDAR, radar, and image fusion data), neural radiance field (NeRF) scene reconstruction, occupancy grid determination, object detection and classification, motion prediction, and other scene understanding tasks for autonomous vehicle operation.

As further provided herein, the application program 335 can comprise a set of instructions for operating the vehicle controls of the autonomous vehicle based on the outputs of the reflex workload pipelines. For example, the application program 335 can be executed by one or more processors 340 of the central chiplet 300 and/or one or more of the workload processing chiplets 320 (e.g., the autonomous drive chiplet 240 of FIG. 2) to dynamically generate a motion plan for the vehicle based on the execution of the reflex workloads, and operate the vehicle's controls (e.g., acceleration, braking, steering, and signaling systems) to execute the motion plan accordingly.

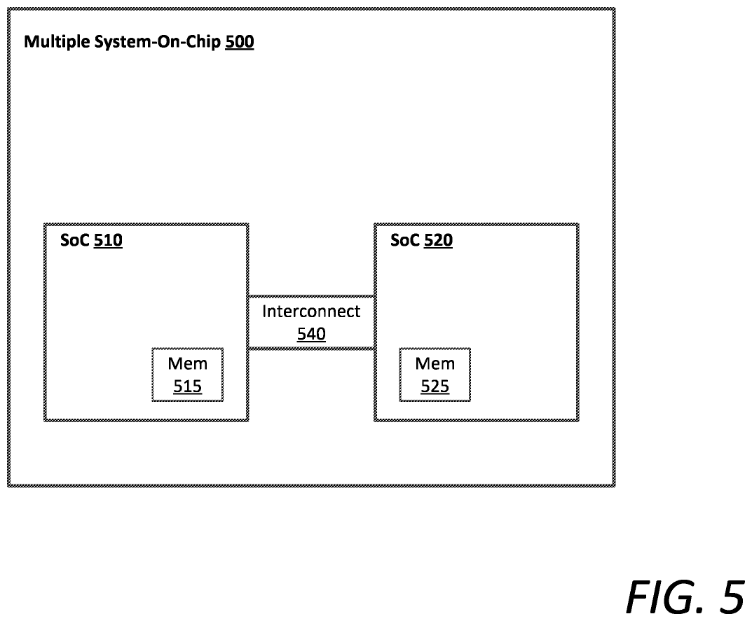

The thermal management program 337 can be executed by one or more processors 340 of the central chiplet to manage heat generated by the SoC, and trigger the switch in roles between primary and backup SoCs in a dual SoC arrangement, such as described with respect to FIG. 5. In various examples, the thermal management program 337 can operate a set of cooling components (e.g., heat sinks, fans, cold plates, heat pipes, synthetic jets, etc.) included with the SoC to manage local temperatures of computational components within normal operating ranges. In further examples, the thermal management program 337 can be executed by a dedicated CPU of the central chiplet 300 and can communicate with the workload processing chiplets 320 and sensor data input chiplet 310 for adjusting clocking or throttling the computing components to further manage temperatures. In certain implementations, the thermal management program 337 can execute on each SoC of a dual or multiple-SoC arrangement, and can further communicate with the FuSa program 338 to, for example, power down a primary SoC when temperatures exceed nominal ranges and enable a backup SoC to take over autonomous inference and driving tasks.

According to examples described herein, the FuSa program 338 can be executed by the one or more processors 340 (e.g., a dedicated FuSa CPU) of the central chiplet 300 to perform functional safety tasks for the SoC. As described throughout the present disclosure, these tasks can comprise acquiring and comparing output from multiple independent pipelines that correspond to inference and/or autonomous vehicle control tasks. For example, one independent pipeline can comprise workloads corresponding to identifying other vehicles operating around the vehicle in image data, and a second independent pipeline can comprise workloads corresponding to identifying other vehicles operating around the vehicle in radar and LIDAR data. The FuSa program 338 can execute FuSa workloads in another independent pipeline that acquires the output of the first and second independent pipelines to dynamically verify that they have identified the same vehicles.

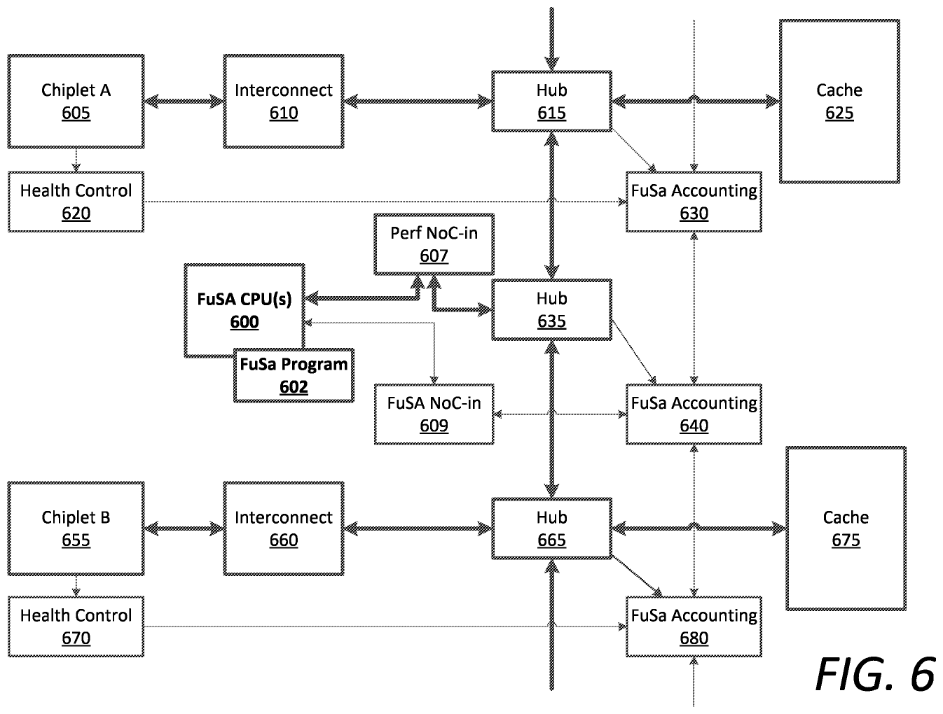

In further examples, the FuSa program 338 can operate to perform SoC monitoring in a dual SoC arrangement in which a primary Soc performs the inference and vehicle control tasks, and a backup SoC performs health monitoring on the primary SoC with its chiplets in a low power standby mode, ready to take over these tasks if any errors, faults, or failures are detected in the primary SoC. Further description of these FuSa functions are described below with respect to FIG. 6. In still further examples, the FuSa program 338 can operate to monitor communications between chiplets and provide redundancy (e.g., via error correction code techniques) to ensure communication reliability between the chiplets. Further description of these techniques is provided below with respect to FIG. 6.

In various implementations, the central chiplet 300 can include a set of one or more processors 340 (e.g., a transient-resistant CPU and general compute CPUs) that can execute a scheduling program 342 for the execution of workloads as runnables in a set of independent pipelines. In certain examples, one or more of the processors 340 can execute reflex workloads in accordance with the reflex program 330 and/or application workloads in accordance with the application program 335. As such, the processors 340 of the central chiplet 300 can reference, monitor, and update dependency information in workload entries of the reservation table 350 as workloads become available and are executed accordingly. For example, when a workload is executed by a particular chiplet, the chiplet updates the dependency information of other workloads in the reservation table 350 to indicate that the workload has been completed. This can include changing a bitwise operator or binary value representing the workload (e.g., from 0 to 1) to indicate in the reservation table 350 that the workload has been completed. Accordingly, the dependency information for all workloads having dependency on the completed workload is updated accordingly.

According to examples described herein, the reservation table 350 can include workload entries, each of which indicates a workload identifier that describes the workload to be performed, an address in the cache memory 315 and/or HBM-RAM of the location of raw or processed sensor data required for executing the workload as a runnable, and any dependency information corresponding to dependencies that need to be resolved prior to executing the workload. In certain aspects, the dependencies can correspond to other runnables that need to be executed prior to the processing of that particular workload. Once the dependencies for the particular workload are resolved, the workload entry can be updated (e.g., by the chiplet executing the dependent workloads, or by the processors 240 of the central chiplet 300 through execution of the scheduling program 342). When no dependencies exist for a particular workload as referenced in the reservation table 350, the workload can be executed as a runnable, or as a part of a runnable comprising multiple workloads, in a respective pipeline by a corresponding workload processing chiplet 320.

In various implementations, the sensor data input chiplet 310 obtains sensor data from the sensor system of the vehicle, and stores the sensor data (e.g., image data, LIDAR data, radar data, ultrasonic data, etc.) in a cache 315 of the central chiplet 300. The sensor data input chiplet 310 can generate workload entries for the reservation table 350 comprising identifiers for the sensor data (e.g., an identifier for each obtained image from various cameras of the vehicle's sensor system) and provide an address of the sensor data in the cache memory 315. An initial set of workloads can be executed on the raw sensor data by the processors 340 of the central chiplet 300 and/or workload processing chiplets 320, which can update the reservation table 350 to indicate that the initial set of workloads have been completed.

As described herein, the workload processing chiplets 320 monitor the reservation table 350 to determine whether particular workloads in their respective pipelines are ready for execution as runnables. As an example, the workload processing chiplets 320 can continuously monitor the reservation table using a workload window (e.g., an instruction window for multimedia data) in which a pointer can sequentially read through each workload entry to determine whether the workloads have any unresolved dependencies. If one or more dependencies still exist in the workload entry, the pointer progresses to the next entry without the workload being executed. However, if the workload indicates that all dependencies have been resolved (e.g., all workloads upon which the particular workload depends have been executed), then the relevant workload processing chiplet 320 and/or processors 340 of the central chiplet 300 can execute the workload accordingly.

As such, the workloads may be executed in an out-of-order manner, where certain workloads are buffered until their dependencies are resolved. Accordingly, to facilitate out-of-order execution of workloads, the reservation table 350 comprises an out-of-order buffer that enables the workload processing chiplets 320 to execute the workloads in an order governed by the resolution of their dependencies in a deterministic manner. It is contemplated that out-of-order execution of workloads can increase speed, increase power efficiency, and decrease complexity in the overall processing of the workloads.

In certain implementations, the workload processing chiplets 320 can execute workloads as runnables in each independent pipeline in a deterministic manner, such that successive workloads of the pipeline are dependent on the outputs of preceding workloads in the pipeline. In various examples, the processors 340 and workload processing chiplets 320 can execute multiple independent workload pipelines in parallel, with each workload pipeline including a plurality of workloads to be executed as runnables in a deterministic manner. Each workload pipeline can provide sequential outputs (e.g., for other workload pipelines or for processing by the application program 335 for autonomously operating the vehicle). Through concurrent execution of the reflex workloads in independent pipelines, the application program 335 can autonomously operate the controls of the vehicle along a travel route.

### Example Software Structure

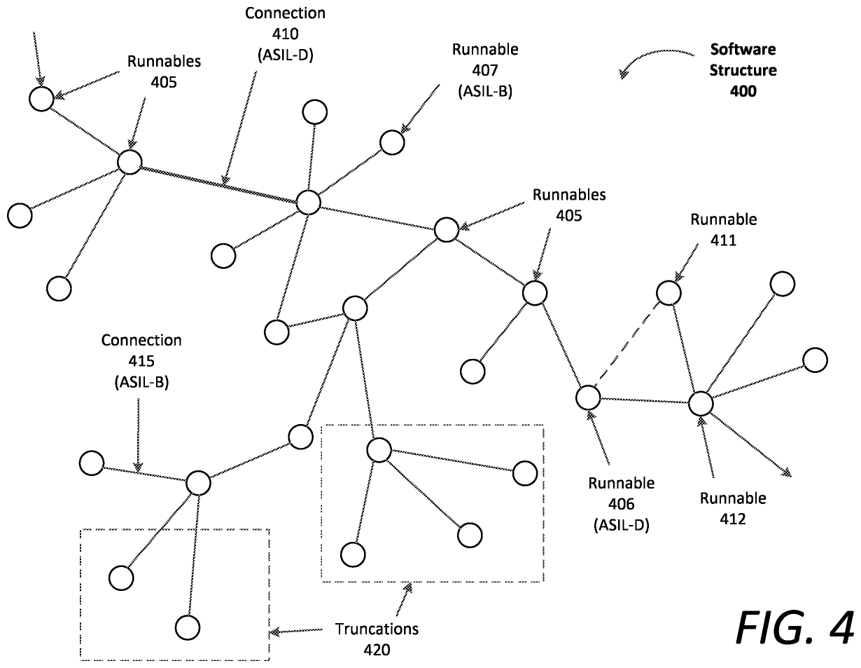

FIG. 4 depicts a software structure 400 comprised of a set of runnables 405 to be executed by workload processing chiplets 320, according to examples described herein. In various implementations, the runnables 405 can be executed by specified hardware components in accordance with the scheduling program 342 and/or FuSa program 338, as shown and described with respect to FIG. 3. For example, the FuSa program 338 can monitor communications corresponding to execution of the runnables 405 by the set of workload processing chiplets 320, and trigger the degradation of the software structure upon detecting one or more degradation events, such as a system overload, processing delays, overheating, excess latency, etc.

The software structure 400 shown in FIG. 4 can correspond to the autonomous driving software used to autonomously operate a vehicle, and is provided for illustrative purposes. Each of the runnables 405 of the software structure 400 can correspond to one or more workload entries in the reservation table 350. As such, when the dependencies of a particular workload entry are resolved, the workload can be executed as a runnable (e.g., by a specified workload processing chiplet 320) in an independent workload pipeline. Accordingly, the collective execution of the runnables 405 in the software structure 400 can correspond to each of the autonomous driving tasks described herein, such as perception, object detection and classification, scene understand, ML inference, motion prediction, motion planning, and/or autonomous vehicle control tasks.

As described herein, the FuSa program 338 can monitor outputs of each workload pipeline to verify them with each other (e.g., to verify consistency between inference runnables). The FuSa program 338 can further monitor communications within the performance network to determine whether any errors have occurred, as described below with respect to FIG. 6. Additionally, the FuSa program 338 can operation in conjunction with the thermal management program 337 to manage heat generated by the SoC 200, switch between primary and backup SoCs in mSoC arrangements (see FIG. 5), and degrade the execution of the software structure 400 based on the safety ratings of the runnables 405 and/or connections between runnables 405 in the software structure 400.

In response to the FuSa program 338 triggering the system degradation, the scheduling program 342 can perform the system degradation of the software structure 400 based on the safety ratings associated with each of the runnables 405 and/or each connection between the runnables 405. In certain scenarios, the scheduling program 342 can perform the degradation by reducing an execution frequency of a select set of runnables in the software structure 400 (e.g., runnables having communication connections with a lower safety rating). As an example, the SoC 200 may be performing scene understanding and inference operations as the autonomous vehicle enters a pedestrian-heavy area. The central chiplet 300 and workload processing chiplets 320 may begin to overheat due to the increased computing requirements of the pedestrian-heavy area, causing the FuSa program 338 to begin the degradation.

As provided herein, certain runnables may be dependent on the outputs of other runnables. For example, a first runnable can involve the detection of external dynamic entities (e.g., pedestrians, other vehicles, bicyclists, etc.) within proximity of the vehicle. A second runnable can involve predicting the motion of each external dynamic entity. Accordingly, the second runnable receives, as input, the output of the first runnable, and therefore these runnables include a connection within the software structure.

In accordance with examples described herein, the software structure 400 can include safety ratings (e.g., ASIL ratings) for certain runnables and the connections between runnables 405. The connections between runnables can correspond to communications and/or dependencies that specified runnables have with each other in the software structure 400. These associated safety ratings can dictate to the FuSa program 338 and scheduling program 342 which runnables, communications, and/or connections between runnables have priority of other runnables, communications, and/or connections when degradation of the system is required (e.g., through throttling to address overheating). The safety ratings can further dictate the importance of the communications between the runnables 405 in terms of safety prioritization. For example, the connection 410 between two runnables having an ASIL-D rating can be prioritized over, say, the connection 415 between two runnables having an ASIL-B rating when degradation of the autonomous drive system is necessary. In such an example, when degradation of the system occurs, the communications or connection between the runnables having an ASIL-B rating can be degraded or throttled whereas the communication between the runnables having the ASIL-D rating can remain robust.

In further examples, each runnable or a subset of the runnables can be associated with a safety rating (e.g., an ASIL rating). As shown in FIG. 4, runnable 407 can be associated with an ASIL-B rating and can comprise a relatively non-essential compute task, whereas runnable 406 can be associated with an ASIL-D rating and can comprise a prioritized compute task. For example, runnable 407 can involve the classification of fire hydrants and/or curb colors in sensor data for the purpose of parking. Runnable 406 can involve motion prediction of pedestrians within proximity of the vehicle, and is therefore critical to the safety of those pedestrians.

For illustration, the software structure 400 can be envisioned as an arrangement of nodes in a compute graph that correspond to the runnables 405, and connections (e.g., connection 410 and connection 415) between the nodes that represent the dependencies or communications between the runnables 405. It is contemplated herein that establishing safety ratings for runnables 405 and/or each connection between runnables 405 can facilitate in an adaptive degradation scheme designed to maintain a high level of safety for the overall autonomous drive system (e.g., an overall ASIL-D rating).

In certain implementations, the FuSa program 338 running on the central chiplet 300 of the computing system executing the software structure 400 (e.g., the SoC 200) can detect when the computing system is experiencing a problem, such as a system overload, processing delays, overheating, or any anomalous occurrences (e.g., heavy rain or snow, lightning strikes, tire failures, braking or steering failures, etc.). In accordance with the established safety ratings for the node connections between the runnables 405, the FuSa program 338 can cause the central chiplet 300 to hierarchically degrade the processes or runnables 405 corresponding to the node connections having lower safety ratings (e.g., ASIL-B ratings) and maintain robustness of the processes or runnables corresponding to the node connections having higher safety ratings (e.g., ASIL-D ratings).

In further examples, degrading the execution of the software structure 400 can involve the FuSa program 338 adaptively truncating or morphing the compute graph (e.g., the portion of the software structure 400 being executed by the workload processing chiplets 320). For example, the connections between runnables 405 in the software structure 400 can be adaptively altered, such that one or more truncated portions of the compute graph are temporarily disregarded. In various embodiments, certain connections between runnables can be rearranged or otherwise edited, such that the outputs of certain runnables become inputs of different runnables. As an illustration, when the FuSa program 338 adaptively morphs the compute graph, the output of runnable 406 can switch from being the input of runnable 412 to being the input of runnable 411. According to examples described herein, the connections between any number of runnables in the software structure 400 can be changed during the degradation process.

As provided herein, degrading the execution of the software structure 400 can involve truncating portions of the compute graph or software structure 400. As shown in FIG. 4, when the FuSa program 338 performs the degradation, one or more runnables or combinations of runnables can be excluded from execution, as depicted by the truncations 420 of the software structure 400. In such an example, the workload processing chiplets 320 will disregard the truncated runnables in the truncations 420 until the degradation is reversed.

Additionally or alternatively, the SoC 200 can store multiple software structures and/or compute graphs that can be executed based on the level of autonomy of the vehicle. For example, when the vehicle switches from SAE level 3 to SAE level 4 autonomy, the SoC 200 can switch from executing an SAE level 3 autonomy software structure to executing an SAE level 4 software structure. In accordance with embodiments provided herein, the SoC 200 can also store multiple software structures and/or compute graphs for degradation purposes. Accordingly, when the FuSa program 338 triggers the degradation, a different software structure and/or compute graph can be executed in the degraded state.

In certain scenarios, the safety rating of runnables and/or connections between runnables 405 can be adapted dynamically (e.g., based on the driving scenario). The process from acquiring sensor data from the vehicle's sensors (e.g., LIDAR sensors, image sensors, radar sensors, etc.), performing preprocessing of the sensor data (e.g., adjusting contrast on acquired images), combining sensor data (e.g., stitching images, sensor fusion, etc.), performing inference tasks (e.g., detecting and classifying objects of interest, such as other vehicles, pedestrians, traffic signage and signals, etc.), to performing motion prediction, motion planning, and vehicle control tasks, can involve a set of safety prioritizations at any given time.

In an example provided, the vehicle can approach an extremely pedestrian-heavy area with the pedestrians in a forward direction of the vehicle—whereas the rear of the vehicle may be relatively devoid of external entities. In such a scenario, the hardware computing components may experience a heavy workload that may cause processing delays and/or overheating. Furthermore, the safety ratings of connections between runnables 405 can be adjusted dynamically based on the driving scenario. The scheduling program 342 can detect the driving scenario, and prioritize the runnables and connections between runnables involving pedestrian detection, which can be associated with an ASIL-D safety rating. In further examples, the scheduling program 342 and/or FuSa program 338 can dynamically adjust the safety ratings of runnables and/or runnable connections for non-essential compute tasks. As provided herein, the degradation can comprise reducing inference or execution frequency of certain runnables, discarding or skipping images, disregarding radar data, and the like.

As such, in certain examples, the scheduling program 342 of the central chiplet 300 can dynamically change the runnable schedule based on the performance of the system in executing the software structure as a whole. The nodes (runnables) and node connections between the runnables 405 in the software structure 400 can comprise fixed or dynamically adjustable safety ratings (e.g., ASIL ratings) based on the driving scenario. It is contemplated that the use of a scheduling program 342 in the mailbox component of the central chiplet 300 (e.g., in an ASIL-D rated memory) to degrade various tasks associated with lower safety ratings can maintain effective operation of the autonomous vehicle in a variety of driving scenarios and a high level of safety of the autonomous drive system as a whole.

### Multiple-System-on-Chip

FIG. 5 is a block diagram depicting an example computing system 500 implementing a multiple system-on-chip (mSoC), in accordance with examples described herein. In various examples, the computing system 500 can include a first SoC 510 having a first memory 515 and a second SoC 520 having a second memory 525 coupled by an interconnect 540 (e.g., an ASIL-D rated interconnect) that enables each of the first SoC 510 and second SoC 520 to read each other's memories 515, 525. During any given session, the first SoC 510 and the second SoC 520 may alternate roles, between a primary SoC and a backup SoC. As provided herein, the primary SoC can perform various autonomous driving tasks, such as perception, object detection and classification, grid occupancy determination, sensor data fusion and processing, motion prediction (e.g., of dynamic external entities), motion planning, and vehicle control tasks. The backup SoC can maintain a set of computational components (e.g., CPUs, ML accelerators, and/or memory chiplets) in a low power state, and continuously or periodically read the memory of the primary SoC.

For example, if the first SoC 510 is the primary SoC and the second SoC 520 is the backup SoC, then the first SoC 510 performs a set of autonomous driving tasks and publishes state information corresponding to these tasks in the first memory 515. The second SoC 520 reads the published state information in the first memory 515 to continuously check that the first SoC 510 is operating within nominal thresholds (e.g., temperature thresholds, bandwidth and/or memory thresholds, etc.), and that the first SoC 510 is performing the set of autonomous driving tasks properly. As such, the second SoC 520 performs health monitoring and error management tasks for the first SoC 510, and takes over control of the set of autonomous driving tasks when a triggering condition is met. As provided herein, the triggering condition can correspond to a fault, failure, or other error experienced by the first SoC 510 that may affect the performance of the set of tasks by the first SoC 510.

In various implementations, the second SoC 520 can publish state information corresponding to its computational components being maintained in a standby state (e.g., a low power state in which the second SoC 520 maintains readiness to take over the set of tasks from the first SoC 510). In such examples, the first SoC 510 can monitor the state information of the second SoC 520 by continuously or periodically reading the memory 525 of the second SoC 520 to also perform health check monitoring and error management on the second SoC 520. For example, if the first SoC 510 detects a fault, failure, or other error in the second SoC 520, the first SoC 510 can trigger the second SoC 520 to perform a system reset or reboot.

In certain examples, the first SoC 510 and the second SoC 520 can each include a functional safety (FuSa) component (e.g., a FuSa program 338 executed by one or more processors 340 of a central chiplet 300, as shown and described with respect to FIG. 3) that performs the health monitoring and error management tasks. The FuSa component can be maintained in a powered state for each SoC, whether the SoC operates in a primary or backup manner. As such, the backup SoC may maintain its other components in a low powered state, with its FuSa component being powered up and performing the heath monitoring and error management tasks described herein.

In various aspects, when the first SoC 510 operates as the primary SoC, the state information published in the first memory 515 can correspond to the set of tasks being performed by the first SoC 510. For example, the first SoC 510 can publish any information corresponding to the surrounding environment of the vehicle (e.g., any external entities identified by the first SoC 510, their locations, and predicted trajectories, detected objects, such as traffic signals, signage, lane markings, and crosswalk, and the like). The state information can further include the operating temperatures of the computational components of the first SoC 510, bandwidth usage and available memory of the chiplets of the first SoC 510, and/or any faults or errors, or information indicating faults or errors in these components.

In further aspects, when the second SoC 520 operates as the backup SoC, the state information published in the second memory 525 can correspond to the state of each computational component of the second SoC 520. In particular, these components may operate in a low power state in which the components are ready to take over the set of tasks being performed by the first SoC 510. The state information can include whether the components are operating within nominal temperatures and other nominal ranges (e.g., available bandwidth, power, memory, etc.).

As described throughout the present disclosure, the first SoC 510 and the second SoC 520 can switch between operating as the primary SoC and the backup SoC (e.g., each time the system 500 is rebooted). For example, in a computing session subsequent to a session in which the first SoC 510 operated as the primary SoC and the second SoC 520 operated as the backup SoC, the second SoC 520 can assume the role of the primary SoC and the first SoC 510 can assume the role of the backup SoC. It is contemplated that this process of switching roles between the two SoCs can provide substantially even wear of the hardware components of each SoC, which can prolong the lifespan of the computing system 500 as a whole.

According to embodiments, the first SoC 510 can be powered by a first power source and the second SoC 520 can be powered by a second power source that is independent or isolated from the first power source. For example, in an electric vehicle, the first power source can comprise the battery pack used for propelling the electric motors of the vehicle, and the second power source can comprise the auxiliary power source of the vehicle (e.g., a 12-volt battery). In other implementations, the first and second power sources can comprise other types of power sources, such as dedicated batteries for each SoC 510, 520 or other power sources that are electrically isolated or otherwise not dependent on each other.

It is contemplated that the mSoC arrangement of the computing system 500 can be provided to increase the safety integrity level (e.g., ASIL rating) of the computing system 500 and the overall autonomous driving system of the vehicle. As described herein, the autonomous driving system can include any number of dual SoC arrangements, each of which can perform a set of autonomous driving tasks. In doing so, the backup SoC dynamically monitors the health of the primary SoC in accordance with a set of functional safety operations, such that when a fault, failure, or other error is detected, the backup SoC can readily power up its components and take over the set of tasks from the primary SoC.

### Functional Safety Accounting

FIG. 6 is a block diagram depicting a performance network and a FuSa network for performing health monitoring, error correction, and system degradation, in accordance with examples described herein. In various examples, the FuSa CPU(s) 600 can be included on a central chiplet 300 of an SoC, or each central chiplet 300 of an mSoC 500 as described herein. Each FuSa CPU 600 can execute a FuSa program 602, which can correspond to the FuSa program 338 as shown and described with respect to FIG. 3. As described herein, execution of the FuSa program 602 can cause the FuSa CPU(s) 600 to perform the primary and backup SoC monitoring tasks described with respect to FIG. 5, and the execution of FuSa workloads in a FuSa pipeline 420 for comparison and verification of independent pipeline output described with respect to FIG. 4.

Furthermore, in the example shown in FIG. 6, multiple chiplets of the SoC can communicate with each other over a high-bandwidth performance network comprising respective sets of interconnects (e.g., interconnect 610 and interconnect 660) and network hubs (e.g., network hubs 615, 635, and 665). As described herein, the multiple chiplets can comprise the sensor data input chiplet 310, central chiplet 300, and workload processing chiplets 320 of FIG. 3, which are represented by chiplet A 605, chiplet B 655, and any number of additional chiplets (not shown) in FIG. 6. Still further, the cache memories 625, 675 shown in FIG. 6 may represent cache memories associated with multiple chiplets and/or the cache memory 315 of the central chiplet 300 as shown and described with respect to FIG. 3.

In various examples, raw sensor data, processed sensor data, and various communications between chiplet A 605, chiplet B 655, and the FuSa CPU(s) 600 can be transmitted over the high-bandwidth performance network comprising the interconnects 610, 660, network hubs 615, 635, 665, and caches 625, 675. For example, if chiplet A 605 comprises a sensor data input chiplet, then chiplet A 605 can obtain sensor data from the various sensors of the vehicle and transmit the sensor data to cache 625 via interconnect 610 and network hub 615. In this example, if chiplet B 655 comprises a workload processing chiplet, then chiplet B 655 can acquire the sensor data from cache 625 via network hubs 615, 635, 665 and interconnect 660 to execute respective inference workloads based on the sensor data.

In certain implementations, the FuSa CPU(s) 600, through execution of the FuSa program 602, can communicate with the high-bandwidth performance network via a performance network-on-chip (NoC) 607 coupled to a network hub 635. These communications can comprise, for example, acquiring output data from independent pipelines to perform the comparison and verification steps described herein. The communications over the high-bandwidth performance network can further comprise communications to access the shared memories 515, 525 of each SoC 510, 520 in a multiple SoC 500 that comprises a primary SoC and a backup SoC. In such examples, the FuSa CPUs 600 of each SoC 510, 520 access the shared memory 515, 525 of each other to determine whether any faults, failures, or other errors have occurred. As described herein, when the backup SoC detects a fault, failure, or error, the backup SoC takes over the primary SoC tasks (e.g., inference, scene understanding, vehicle control tasks, etc.).

In some aspects, the interconnects 610, 660 are used as a high-bandwidth data path used for general data purposes to the cache memories 625, 675, and health control modules 620, 670 and FuSa accounting hubs 630, 640, and 680 are used as a high-reliability data path to transmit functional safety and scheduler information to the shared memory of the SoC. NoCs and network interface units (NIUs) on chiplet A 605 and chiplet B 655 can be configured to generate error-correcting code (ECC) data on both the high-bandwidth and high-reliability data paths. Each corresponding NIU on each pairing die has the same ECC configuration, which generates and checks the ECC data to ensure end-to-end error correction coverage.

According to various embodiments, the FuSa CPU(s) 600 communicates via a FuSa network comprising the FuSa accounting hubs 630, 640, 680 and health control modules 620, 670 via a FuSa NoC 609. As provided herein, the FuSa network facilitates the communication monitoring and error correction code techniques. As shown in FIG. 6, a FuSa accounting hub 630, 640, 680 can monitor communications transmitted through each network hub 615, 635, 665 of the high-bandwidth network. Each of chiplet A 605 and chiplet B 655 can communicate with or include a health control module 620, 670 through which ECC data, workload start and end communications, and scheduling information can be transmitted.

For the FuSa network data paths, the NIUs can transmit the functional safety and scheduler information through the health control modules 620, 670 in two redundant transactions, with the second transaction ordering the bits in reverse (e.g., from bit 31 to 0 on a 32-bit bus) of the order of the first transaction. Furthermore, if errors are detected in the data transfers between chiplet A 605 and chiplet B 655 over the high-reliability FuSa network, the NIUs can reduce the transmission rate to improve reliability.

In some examples, certain processors of chiplet A 605, chiplet B 655, and/or the FuSa CPU(s) 600 can include a transient-resistant CPU core to run the scheduling program 342 of FIG. 3, which schedules workloads belonging to the reflex program 330, application program 335, thermal management program 337, and/or the FuSa program 602. The transient-resistant CPU cores are designed to resist and recover from transient faults caused by environmental factors such as cosmic radiation, power surges, and electromagnetic interference. These faults can cause the CPU to malfunction or produce incorrect results, potentially leading to system failures or security vulnerabilities. To address these issues, the transient-resistant CPU cores can include a range of hardware-based fault detection and recovery mechanisms, such as redundant execution units, error-correcting code (ECC) memory, and register duplication. These mechanisms can detect and correct errors in real-time, ensuring that the CPU continues to function correctly even in the presence of transient faults. Additionally, the transient-resistant CPU cores may include various software-based fault tolerance techniques, such as checkpointing and rollback, to further enhance system reliability and resilience.

In some aspects, the health control modules 620, 670 and FuSa accounting hubs 630, 640, 680 can detect and correct errors in real-time, ensuring that the CPUs continue to function correctly even in the presence of transient faults. For example, workload processing chiplet A and the central chiplet can perform an error correction check to verify that the processed data was sent and stored in the cache memories 625, 675 completely and without corruption. For example, for each processed data communication, the workload processing chiplets can generate an error correction code (ECC) using the processed data and transmit the ECC to the central chiplet. While the data itself is transmitted along a high-bandwidth performance network between chiplets, the ECC is sent along a high-reliability FuSa network via the FuSa accounting hubs 630, 640, 680. Upon receiving the processed data, the central chiplet can generate its own ECC using the processed data, and the FuSa CPU 600 can perform a functional safety call in the central chiplet mailbox to compare the two ECCs to ensure that they match, which verifies that the data was transmitted correctly.

In accordance with examples described herein, the FuSa CPU 600 and FuSa program 602 can further monitor communications in the performance network and reliability network for evidence that the system is experiencing system overload, network latency, low bandwidth, and/or overheating. Upon detecting these issues, the FuSa program 602 can perform any number of mitigation measures, such as switching the primary and backup roles of SoCs in an mSoC 500 arrangement, or initiating system degradation in the manner described throughout the present disclosure.

### Methodology

FIGS. 7 and 8 are flow chart describing example methods of adapting runnables based on safety rating, according to various examples. In the below discussions of the methods of FIGS. 7 and 8, reference may be made to reference characters representing certain features described with respect to the diagrams of FIGS. 1 through 6. Furthermore, the steps described with respect to the flow charts of FIGS. 7 and 8 may be performed by the computing system 100, the workload processing chiplets 320 and central chiplet 300 of the SoC 200, and/or the mSoC 500 as shown and described with respect to FIGS. 1 through 6. Further still, certain steps described with respect to the flow charts of FIGS. 7 and 8 may be performed prior to, in conjunction with, or subsequent to any other step, and need not be performed in the respective sequences shown. In further implementations, the “computing system” described in connection with FIGS. 7 and 8 can refer to any computing system, and is not limited to on-board computing systems of autonomous or semi-autonomous vehicles. For example, the computing system can be included on a robotic system, aerial vehicle, sea-going vehicle, autonomous farming equipment, server farm or datacenter, personal computing device, etc.

Referring to FIG. 7, at block 700, a computing system can obtain sensor data from a sensor system. As provided herein, the sensor system can include one or more sensor types, such as LIDAR sensors, image sensors or cameras, radar sensors, ultrasonic sensors, microphones, proximity sensors, and the like. In further implementations, the sensor system can be included on an autonomous vehicle or semi-autonomous vehicle, and can provide a continuous sensor view of a surrounding environment of the vehicle. At block 705, based on the sensor data, the computing system can schedule execution of runnables 405 (e.g., via scheduling program 342) in accordance with a software structure 400. As provided herein, the software structure 400 can comprise all the software required to perform the reflex and/or application functions described above, which can combine to perform all sensor data acquisition, perception, object detection and classification, scene understanding, ML inference, motion prediction, motion planning, and/or vehicle control tasks required to autonomously operate the vehicle along a travel path.

In various embodiments, the software structure 400 can define runnables 405 and connections between runnables 405 where associations or dependencies exist. For example, an output of a first runnable (e.g., an object detection algorithm that identifies any objects of interest in sensor-fused data) can be included as an input of a second runnable (e.g., an object classification algorithm that classifies each of the detection objects), the output of which can be included as an input of a third runnable (e.g., a motion prediction algorithm tasked to prediction the motion of each dynamic object classified by the second runnable), and so on. As provided herein, these runnables can be executed in accordance with a dynamic schedule and reservation table 350 that identifies when workloads corresponding to each runnable are available (e.g., dependency information for the workload has been satisfied or otherwise resolved).

As provided herein, each connection or a subset of connections between runnables 405 in the software structure 400 can be associated with a safety rating (e.g., an ASIL rating). More critical connections between runnables can be associated with higher safety ratings than less critical connections. For example, connections between runnables processing data in a forward operational direction of the vehicle can be associated with higher safety ratings than connections between runnables processing data for the rear of the vehicle. As another example, connections between runnables involving the detection of pedestrian or other vulnerable road users (VRUs) can include higher safety ratings than connections between runnables involving the detection of fire hydrants, curb colors, parking meters, and the like.

At block 710, during execution of the runnables 405 in the software structure 400, the computing system can detect a degradation event in the computing system. As provided herein, the degradation event can correspond to a system overload, such as an overload of compute tasks or runnables required to safely navigate a given travel path. These scenarios may occur when the vehicle enters a high-process load area, such as a dense urban environment (e.g., extreme cases of pedestrians, bicycle lanes, external vehicles, traffic signage, etc.), and/or an area with complex traffic and right-of-way rules. In further examples, the degradation event can correspond to one or more sensor failures, such as a camera or LIDAR sensor failing and forcing the computing system to rely on other forms of sensor data.

As another example, the degradation event can correspond to the computing system heating up or beginning to overheat (e.g., due to increased processing, hardware wear, a hardware failure, thermal run-up, etc.). In such an example, the thermal management program 337 can perform a set of thermal mitigation tasks, such as enabling heat sinks, cooling fans, radiators, and/or switching between a primary and backup SoC in an mSoC 500 computing system embodiment. In the case of thermal run-up, the temperature increases can cause the resistance in wires and other computer components to decrease, which can cause the temperature to increase further in a critical feedback cycle. In such a scenario, the FuSa program 338 can detect the thermal run-up (e.g., through monitoring the performance network, and initiate degradation in the manner described herein. For example, when the level of heat generated after the thermal mitigation measures still exceeds critical temperatures, at block 715, the FuSa program 338 can cause the computing system to selectively degrade the execution of runnables 405 in the software structure 400 based on the safety ratings of the runnables and/or the connections between the runnables in the software structure 400.

As described herein, this degradation can comprise reducing the processing frequency of selected device (e.g., a specific workload processing chiplet) where the runnables are executed and whose runnables or runnable connections have relatively lower safety ratings (e.g., disregarding every other image or sensor data iteration), decreasing the frequency of how often specific compute tasks or runnables are executed, ignoring data from certain non-critical sensors, temporarily preventing execution of certain runnables, and the like. As further described herein, this degradation can be implemented by the scheduling program 342 using the reservation table 350, which can indicate when certain workloads are available for execution as runnables. For example, the scheduling program 342 can cause certain workloads in an out-of-order buffer of the reservation table 350 to be flushed without being executed (e.g., data corresponding to the workload can be transferred to an HBM chiplet without being processed by a workload processing chiplet 320) or the reservation table 350 can selectively delete certain workloads associated with runnables having low safety rating connections. It is contemplated that such methods can be included on autonomous vehicle computing systems to prevent system faults, failures, or increased wear from excess heat, which can provide additional redundancy to the thermal management program 337 and mSoC 500 arrangement that can increase the overall ASIL rating of the entire computing system.

FIG. 8 is another flow chart describing a method of adapting runnables based on safety rating, according to various examples. Referring to FIG. 8, at block 800, the FuSa program 338 of the computing system can detect a degradation event while the computing system executes runnables 405 in a software structure 400 in accordance with a schedule. At block 805, the computing system may then determine the driving scenario to infer whether the driving scenario is associated with the degradation event. As provided herein, the runnables and/or connections between runnables 405 in the software structure 400 can be associated with safety ratings (e.g., ASIL ratings), which can be dynamically adjusted or configured based on the driving scenario.

At block 810, the computing system can configure or adjust the safety ratings of runnables and/or runnable connections in the software structure 400. For example, the driving scenario may involve a transition in driving environments (e.g., from a highway in which runnables processing forward sensor data is prioritized, to an urban environment where runnables processing closer proximity data are more important). In further examples, the degradation trigger for initiating degradation can comprise the changing driving scenario itself (e.g., as opposed to the computing system overheating). In such examples, the reflex program (performing inference operations) can trigger the scheduling program 342 of the computing system to preemptively initiate the degradation processes described herein.

In various implementations, at block 815, the computing system can selectively degrade the execution of the software structure 400 based on the reconfigured or adjusted safety ratings of the connections between the runnables 405. In certain examples, the safety ratings of the runnables and/or runnable connections may be hierarchically adaptive or adjustable. For example, when the system performs a “level one” degradation, certain runnable connections that may be inessential given the driving scenario may still include a high safety rating.

In such an example, at decision block 820, the FuSa program 338 of the computing system can determine whether the degradation event has been resolved. If not, the FuSa program 338 can reconfigure the safety ratings and cause the scheduling program 342 to hierarchically degrade additional runnables or runnable connections (e.g., “level two” degradation, etc.) until the degradation event has been resolved (e.g., the system cools below critical temperature thresholds). When the degradation event has been resolved (e.g., through temperature decrease and/or change in driving scenario), at block 825, the scheduling program can selectively and/or hierarchically reverse the degradation accordingly.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature.

What is claimed is:

1. A computing system comprising:
a sensor data input chiplet to obtain sensor data from a sensor system;
a set of workload processing chiplets; and
central chiplet comprising a shared memory including a scheduling program for scheduling a set of runnables to execute based at least partially on the sensor data, the set of runnables being included in a software structure for execution by the set of workload processing chiplets, wherein each runnable and each connection between runnables in the software structure is associated with a safety rating to facilitate degradation of execution of the software structure.

2. The computing system of claim 1, wherein the safety rating of each runnable and each connection between the runnables comprises an automotive safety integrity level (ASIL) rating.

3. The computing system of claim 1, wherein the central chiplet includes a functional safety (FuSa) program that (i) monitors communications corresponding to execution of the runnables by the set of workload processing chiplets, and (ii) triggers the degradation upon detecting data corresponding to a system overload, processing delay, or overheating.

4. The computing system of claim 3, wherein, in response to the FuSa program triggering the degradation, the scheduling program performs the degradation based on the safety rating of each runnable and each connection between the runnables.

5. The computing system of claim 4, wherein the degradation by the scheduling program comprises reducing an execution frequency of a select set of runnables in the software structure.

6. The computing system of claim 5, wherein the scheduling program reduces the execution frequency of the select set of runnables using a reservation table that identifies when the select set of runnables are ready for execution.

7. The computing system of claim 3, wherein the FuSa program triggers the degradation by performing at least one of: (i) morphing the software structure to change one or more connections between the runnables, or (ii) truncating the software structure to exclude one or more runnables from being executed.

8. The computing system of claim 1, wherein the sensor data input chiplet, the set of workload processing chiplets, and the central chiplet are included on a Universal Chiplet Interconnect Express (UCIe) system-on-chip (SoC) arrangement.

9. The computing system of claim 1, wherein the computing system comprises an on-board vehicle computer for an autonomous vehicle.

10. A non-transitory computer readable medium storing instructions that, when executed by one or more processors of a computing system, cause the computing system to:
obtain, using a sensor data input chiplet, sensor data from a sensor system;
schedule, via execution of a scheduling program on a central chiplet comprising a shared memory, a set of runnables to execute based at least partially on the sensor data, the set of runnables being included in a software structure by a set of workload processing chiplets, wherein each runnable and each connection between runnables in the software structure is associated with a safety rating to facilitate degradation of execution of the software structure.

11. The non-transitory computer readable medium of claim 10, wherein the safety rating of each runnable and each connection between the runnables comprises an automotive safety integrity level (ASIL) rating.

12. The non-transitory computer readable medium of claim 10, wherein the central chiplet includes a functional safety (FuSa) program that (i) monitors communications corresponding to execution of the runnables by the set of workload processing chiplets, and (ii) triggers the degradation upon detecting data corresponding to a system overload, processing delay, or overheating.

13. The non-transitory computer readable medium of claim 12, wherein, in response to the FuSa program triggering the degradation, the scheduling program performs the degradation based on the safety rating of each runnable and each connection between the runnables.

14. The non-transitory computer readable medium of claim 13, wherein the degradation by the scheduling program comprises reducing an execution frequency of a select set of runnables in the software structure.

15. The non-transitory computer readable medium of claim 14, wherein the scheduling program reduces the execution frequency of the select set of runnables using a reservation table that identifies when the select set of runnables are ready for execution.

16. The non-transitory computer readable medium of claim 12, wherein the FuSa program triggers the degradation by performing at least one of: (i) morphing the software structure to change one or more connections between the runnables, or (ii) truncating the software structure to exclude one or more runnables from being executed.

17. The non-transitory computer readable medium of claim 10, wherein the sensor data input chiplet, the set of workload processing chiplets, and the central chiplet are included on a Universal Chiplet Interconnect Express (UCIe) system-on-chip (SoC) arrangement.

18. The non-transitory computer readable medium of claim 10, wherein the computing system comprises an on-board vehicle computer for an autonomous vehicle.

19. A computer-implemented method of adapting runnables, the method being performed by one or more processors and comprising:
obtaining, using a sensor data input chiplet, sensor data from a sensor system;
scheduling, via execution of a scheduling program on a central chiplet comprising a shared memory, a set of runnables to execute based at least partially on the sensor data, the set of runnables being included in a software structure by a set of workload processing chiplets, wherein each runnable and each connection between runnables in the set of runnables is associated with a safety rating to facilitate degradation of execution of the software structure.

20. The method of claim 19, wherein the safety rating of each runnable and each connection between the runnables comprises an automotive safety integrity level (ASIL) rating.
